(19) United States
(12) Patent Application Publication
(10) Pub. No.: US 2015/0252775 A1
(43) Pub. Date: Sep. 10, 2015

(54) ENDLESS LOOP DISPLACEMENT BELT

(71) Applicant: Robert Miller, Franklin, VA (US)

(72) Inventor: Robert Miller, Franklin, VA (US)

(21) Appl. No.: 14/638,607

(22) Filed: Mar. 4, 2015

Related U.S. Application Data
(60) Provisional application No. 61/966,789, filed on Mar. 4, 2014.

(51) Int. Cl. F03B 7/00

(52) U.S. Cl. CPC F03B 7/003; F03B 7/006

(57) ABSTRACT

The invention relates to an energy producing device by the process of fluid displacement on an endless loop belt with containers that capture air or gas bubbles and water or fluid flowing down from above the belt moving in a downward direction and the openings are on top for caching fluid and on the side for capturing bubbles the containers are open at the bottom moving in an upward direction the potential energy is multiplied by the number of containers fixed to the belt.

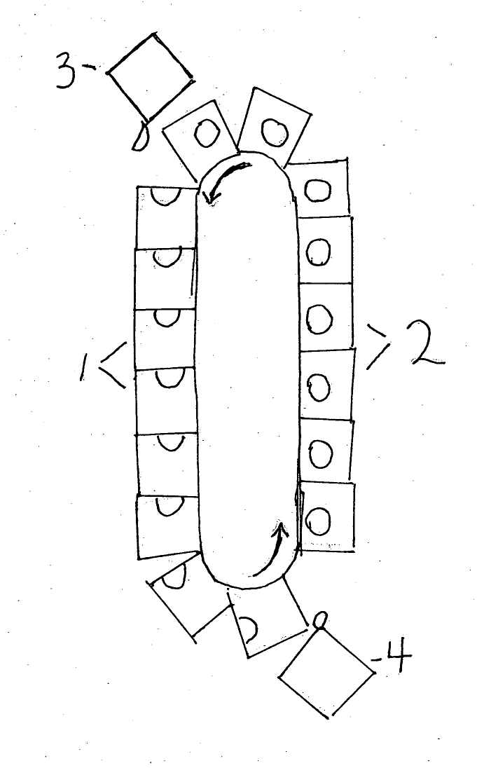

The endless loop displacement belt is rotated between two vertically oriented axes with half of the endless loop displacement belt submerged. The direction is determined by the containers attached to the endless loop belt. The opening at the top for capturing fluid flowing downward, and the other side of the rotating endless loop displacement belt open at the bottom of the containers capturing floating air or gas bubbles, while the endless loop displacement belt is in the upward movement, this reduces negative resistance with stored energy that is conveyed in the process of fluid displacement by air or gas mixtures in the containers fixed to the endless loop displacement belt.

### BACKGROUND

Water wheel like devices have no or little potential energy this problem is solved by using containers fixed to or modules attached in an endless loop belt configuration rotating on vertically or angled axes adding energy multiplied by the number of containers previously filled.

SUMMERY OF THE INVENTION

It is the objective of the present invention to provide clean efficient energy by the process of displacement of fluid combined with a water wheel like process of producing energy.

### BRIEF DESCRIPTION OF DRAWING

A non-limiting embodiment of the present invention will be described by way of example with reference to the drawing.

1 are the containers with the opening at the top for capturing fluid.

2. are the containers when the opening is at the bottom for capturing air or gas bubbles.

3. is the water or fluid source.

4. is the air or gas source.

### DETAILED DESCRIPTION

The endless loop displacement belt is displayed in the drawing as a block diagram where blocks numbered 1 are the containers with the opening at the top for capturing water or fluid and the blocks numbered 2 are the containers when the containers are open on the bottom for capturing bubbles floating upwards on the endless loop displacement belt the block numbered 3 is the water or fluid source and the block numbered 4 is the air or gas source and the arrows show the direction the endless loop displacement belt is rotating between two axes and the preferred mode of operation is when the belt is half way submerged and both the flowing fluid and air or gas bubbles are used to rotate the endless loop displacement belt the water wheel like process is enhanced by the previously filled containers fixed to the endless loop vertically configured belt and the containers capturing air or gas use the process of displacement to increase the energy combining kinetic and potential by the stored energy produced using buoyant energy multiplied by the previously air or gas filled containers that are submerged in a fluid containment unit that the endless loop displacement belt is vertically oriented in the size and amount of containers determine the amount of energy that the endless loop displacement belt produces and transfers to a hub with a belt pulley or chain sprocket attached using a belt or chain to the desired mechanical device requiring kinetic energy.

### FIELD OF THE INVENTION

The present invention relates to the clean energy field such as water wheel type devices.

Those skilled in the art will realize that various changes and modifications may be made to the invention without departing from the spirit and process of the endless loop displacement belt.

1. An endless loop belt configuration comprising of containers attached in a modular fashion with the opening capable of capturing air or gas bubbles in the containers that are also capable of capturing flowing water or fluid the characterized device has three modes of operation dependent on water or fluid level when the device is completely submerged the device uses captured floating air or gas bubbles displacing water or fluid using buoyant force to rotate the belt on the vertical or angle oriented axes the distance between dependent on the number and size of modules attached in a endless loop belt configuration.

2. If said device uses free flowing water or fluid the modules are filled on the downward moving side of the belt with the opening at the top of the modules to capture fluid flowing down from a source above the belt the potential energy is increased by the number and size of modules previously filled while the belt is rotating around two or more axes.

3. If said device uses air or gas bubbles and flowing water or fluid the fluid is captured in the containers oriented with the opening at the top of the modules on the side of the belt moving in the downward direction and capturing floating bubbles on the upward moving side of the belt reducing drag from the modules moving through the fluid by adding buoyant force and potential energy increased by the size and number of containers submerged and on the fluid side the number of containers that are previously filled above fluid level between vertically oriented axes.
